(19) United States
(12) Patent Application Publication
(10) Pub. No.: US 2006/0073959 A1
(43) Pub. Date: Apr. 6, 2006

(54) Methods, apparatus, and systems for assembling containers

(75) Inventor: Klaus Michael Koessendrup, Schifferstadt (DE)

Correspondence Address: Schwegman, Lundberg, Woessner & Kluth, P.A., P.O. Box 2938, Minneapolis, MN, 55402, US

(73) Assignee: Weidenhammer Packaging LP

(21) Appl. No.: 11/287,416

(22) Filed: Nov. 23, 2005

Related U.S. Application Data
(63) Continuation-in-part of application No. 10/899,877, filed on Jul. 27, 2004.

(51) Int. Cl. B31C 1/04

(52) U.S. Cl. 493/308

(57) ABSTRACT

Methods, apparatus, and systems are provided for assembling containers. A rotating device includes fixtures. Each fixture receives a sidewall for a container and a plastic ring. The fixture rotates to a pressing station where the sidewall is pressed into the ring. Further, the fixture rotates to a bottom station where a bottom is affixed to the sidewall. In an embodiment, the sidewall, which represents the container, is removed from the fixture and the rotating device.

### RELATED APPLICATIONS

The present invention is a Continuation-In Part of U.S. application Ser. No. 10/899,877; filed on Jul. 27, 2004; entitled “Commercial Bulk Ice Cream or Frozen Novelty Container and Method of Manufacture.” The disclosure of which is incorporated by reference herein.

### FIELD

The invention relates generally to packaging and more particularly to methods, apparatus, and systems for assembling containers used in packaging.

### BACKGROUND

Techniques for packaging goods include a wide variety of processes, equipment, and materials. Some goods are packaged in containers that are plastic, paper-based, metal, or various combinations of these things. In recent years, packaging has taken more of a custom design flare in attempts to attract consumers to particular goods.

Commercial frozen novelty is one area of packaging, which is concerned with containing, transporting, and dispensing frozen novelty products. Typically, containers associated with these types of products are made of paper-based materials, plastic, and/or metals. Metal material poses a variety of health and safety concerns for the frozen novelty containers because when product is dispensed a hand can be cut and blood may spill into the product; and the product may not be capable of being subjected to metal detection to ensure that no foreign metal material is within the product when the container includes a metal support ring. Furthermore, the more variety of materials used in the construction of a frozen novelty container the more complicated and expensive the container manufacturing process can become.

### SUMMARY

In various embodiments, techniques are provided for assembling containers. More particularly and in an embodiment, a method of assembling a container is provided. A plastic ring is received over a fixture and a sidewall of a container is received over the fixture and on top of the plastic ring. The sidewall is pressed into the plastic ring and a bottom is affixed to an end of the sidewall that is opposite the plastic ring.

### BRIEF DESCRIPTION OF THE DRAWINGS

FIG. 1 is a diagram of a method for assembling a container, according to an example embodiment.

FIG. 2 is a diagram of a container assembly apparatus, according to an example embodiment.

FIG. 3A is a diagram of a rotating device having a plurality of fixtures and which is part of the container assembly apparatus of the FIG. 2, according to an example embodiment.

FIG. 3B is a diagram of a setup station for the container assembly apparatus of the FIG. 2, according to an example embodiment.

FIG. 3C is a diagram of a pressing device for the container assembly apparatus of FIG. 2, according to an example embodiment.

FIG. 3D is a diagram of a heat sealing device for the container assembly apparatus of FIG. 2, according to an example embodiment.

FIG. 3E is a diagram of a suction device for the container assembly apparatus of FIG. 2, according to an example embodiment.

FIG. 4 is a diagram of a container assembly system, according to an example embodiment.

### DETAILED DESCRIPTION

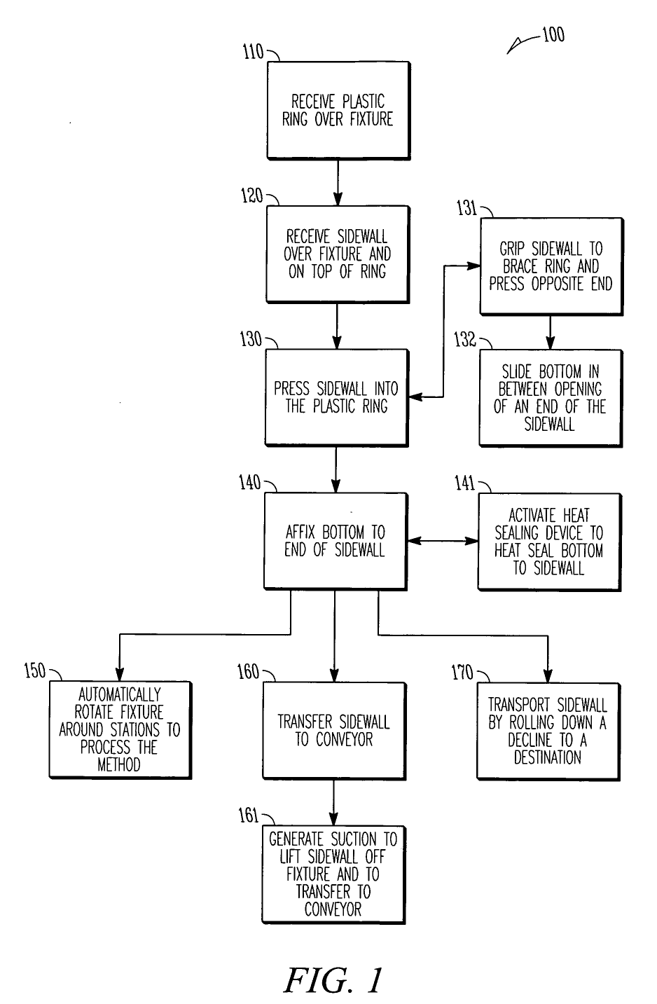

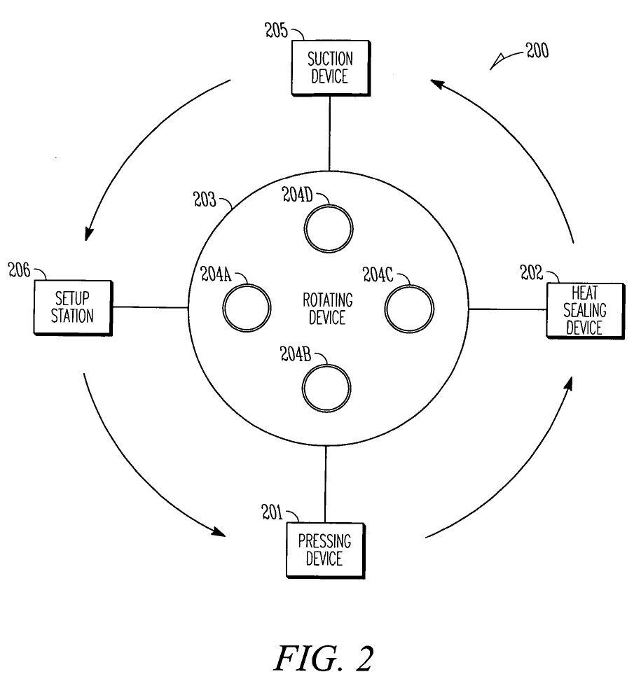

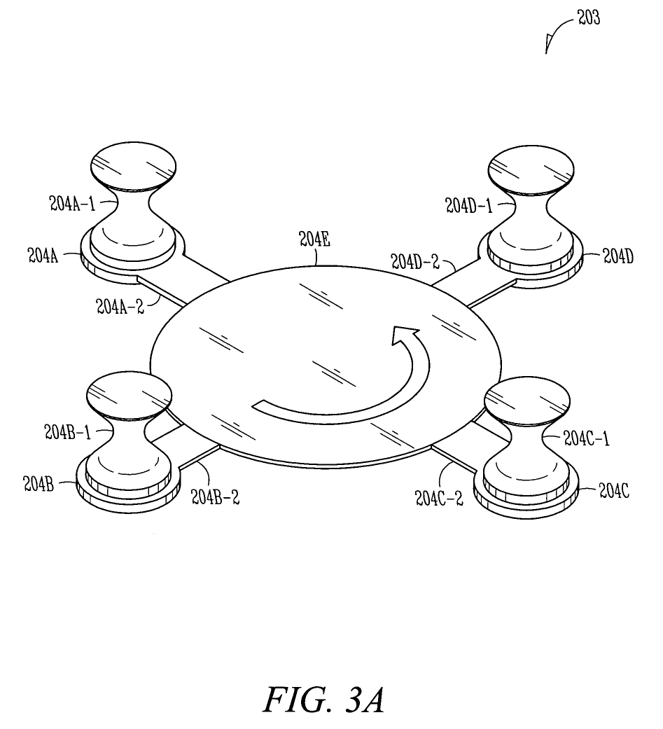

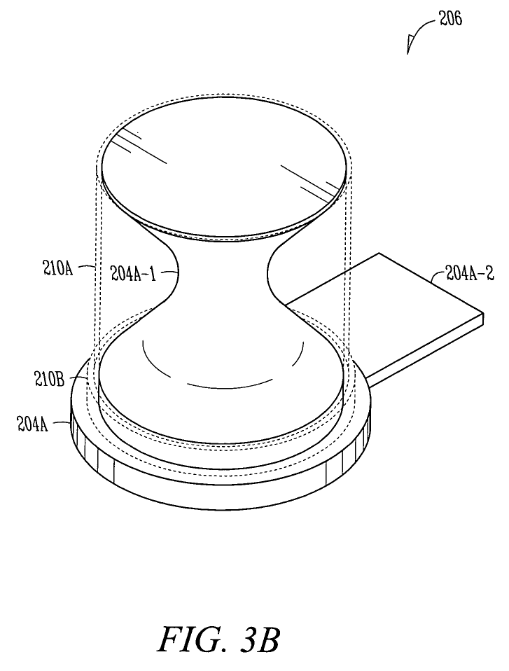

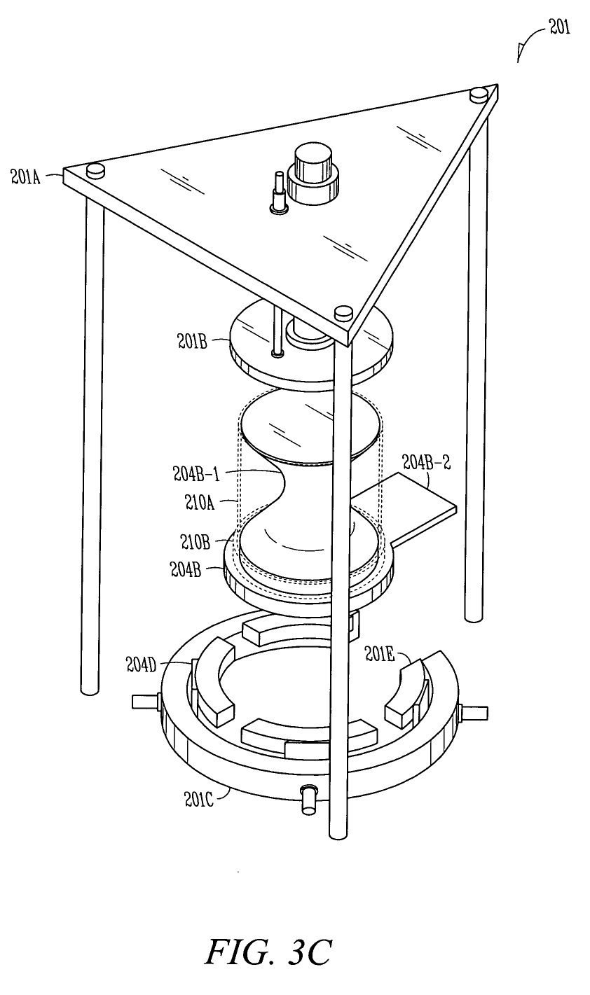

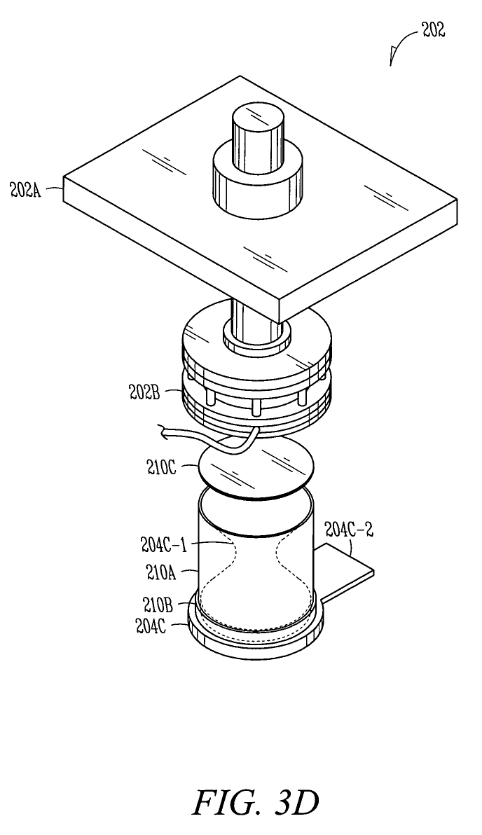

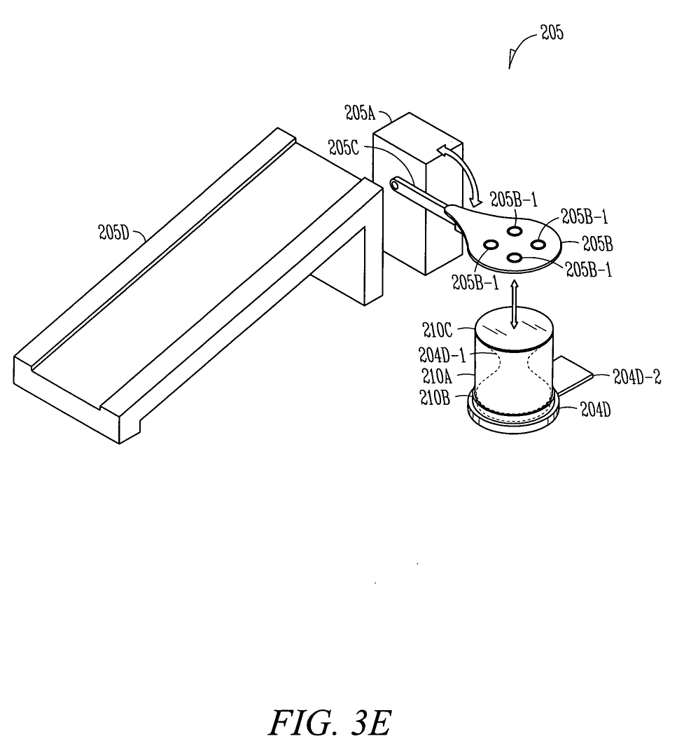

FIG. 1 is a diagram of a method 100 for assembling a container, according to an example embodiment. The method 100 is processed within a fabrication environment for producing or assembling containers. Equipment adapted to perform the method 100 may be used. Some example apparatus are provided below with respect to FIG. 2 and FIGS. 3A-3E.

In an embodiment, the containers are commercial frozen novelty containers that are made of paper-based material and plastic rings. The containers include a sidewall, a plastic ring, and a bottom. The plastic ring is affixed to a top of the sidewall to supply support. Furthermore, the plastic ring is pressed or snapped onto the top of the sidewall. A bottom is sealed to an end opposite that of the plastic ring. In some cases, the bottom is also made of paper-based material and is heat sealed to the perimeter sides of the sidewall.

At 110, a plastic ring is received over a fixture. The fixture is designed to be about the same vertical height as a sidewall for the container or in some cases slightly less than the vertical height. Moreover, the fixture may include a bottom most circumference and topmost circumference that is slightly less then a circumference of the sidewall and the plastic ring. The middle portion of the fixture may or may not be substantially smaller in circumference from that of the bottom most and topmost portions of the fixture. Some examples of fixtures are provided in FIGS. 3A-3E.

At 120, the sidewall is placed over the fixture and on top of the plastic ring. In an embodiment, the fixture is affixed to a rotating device or circular conveyor and is associated with a plurality of other stationary fixtures affixed at predefined distances on the rotating device.

In some cases, the processing of 110 and 120 may be a manual process where an operator places the plastic ring and the sidewall over the fixture. In other cases a robotic arm or other mechanical device may be used to drop the plastic ring and the sidewall over the fixture in the proper order and sequence. Thus, the processing of 110 and 120 may be automated or may be partially manual.

At 130, the sidewall is pressed, beginning at a top portion of the fixture in a direction toward the bottom portion of the fixture, into the plastic ring. The fixture itself is not pressed. It is the sidewall that is pressed and snapped or affixed into the plastic ring. The plastic ring resides at the bottom portion of the fixture and is situated upside down so as to receive the top perimeter of the sidewall.

In an embodiment, at 131, the mechanism by which the sidewall is pressed into the ring is such that a gripping or stabilizing device rises from underneath the fixture and grips, stabilizes, and braces the ring to withstand a force of the sidewall being pressed by a pressing device from the other end of the sidewall. An example of such a device or apparatus is provided in FIGS. 2 and 3C below. At 132, the process of pressing and gripping results in the sidewall being slid between two sides of the plastic ring, the two sides oppose one another and the opening between the two sides of the plastic ring is slightly less then the width of the sidewall. Consequently, the sidewall is forced into the plastic ring and affixed to the plastic ring.

The pressing of the sidewall into the plastic ring, as they both surround the fixture, is achieved via an automatic and mechanical mechanism using devices designed to achieve the same.

At 140, a bottom is affixed to an end of the sidewall. The end is opposite from where the plastic ring is affixed to the sidewall. In an embodiment, the bottom is a paper-based product. According to an embodiment, at 141, the bottom is affixed by heat sealing the bottom to the perimeter of the sidewall using a heat seal device or mechanism. An example of such a heat sealing device is provided below with respect to FIG. 3D. Moreover, in some embodiments, a device may slide the bottom in between the topmost portion of the fixture having the sidewall and the hat sealing device. The heat sealing device then lowers itself onto and around the bottom and the perimeter of the sidewall for purposes of heat sealing the bottom to the sidewall. Again, the processing of 140 may occur in an entirely automated fashion using mechanical devices configured to achieve the heat seal of the bottom to the sidewall.

According to an embodiment, the fixture is situated on a rotating device or conveyor mechanism and is rotated around stations, such that each station performs the processing of 110 and 120, 130, or 140. Examples of such a rotating device are provided below with respect to FIGS. 2, 3A, and 4.

In an embodiment, at 160, the sidewall is transferred from the fixture to a conveyor. This may be achieved, at 161, by generating suction against the bottom, which is affixed to the sidewall, and lifting the newly assembled container off the fixture and then placing the container or sidewall on a conveyor. According to an embodiment, 170, the conveyor is an elevated ramp that permits the container to roll down a decline associated with the ramp to a destination or stacking processing station.

Mechanical arrangements and devices for performing the method 100 will now be discussed in greater detail with the FIGS. 2-4.

FIG. 2 is a diagram of a container assembly apparatus 200, according to an example embodiment. The container assembly apparatus 200 includes a variety of mechanical and electrical devices that cooperate to perform the processing described above with respect to the method 100 of FIG. 1.

The container assembly apparatus 200 includes a pressing device 201, a heat sealing device 202, and a rotating device 203. In some embodiments, the container assembly apparatus 200 may also include one or more fixtures 204A-D, a suction device 205, and/or a setup station 206. Each of these will now be discussed in turn.

The pressing device 201 is for affixing a plastic ring to a sidewall. The pressing device 201 may be any electromechanical device that is configured to press a sidewall into a plastic ring, which thereby affixes the plastic ring to the sidewall. An example illustration of a pressing device 201 is provided in FIG. 3C and is discussed in greater detail below.

The heat sealing device 202 is for sealing a bottom to the sidewall. The processing of the heat sealing device 202 may occur after the ring is affixed to the sidewall by the pressing device 201. Again, the heat sealing device 202 may be any electromechanical device designed to heat a coating on the sidewall and/or bottom to form an adhesion of the bottom to the perimeter of the sidewall. In an embodiment, the bottom is slightly recessed from the bottom of the sidewall once heat sealed to the sidewall. In other cases, the bottom is flush with the bottom of the sidewall once heat sealed to the sidewall. An example illustration of a heat sealing device 202 is provided in FIG. 3D and is discussed in greater detail below.

The rotating device 203 is for moving a sidewall that is being assembled with the plastic ring and the bottom from the pressing device 201 to the heat sealing device 202. The rotating device 203 is an electromechanical device designed to automatically rotate at defined amount at defined intervals or to rotate when instructed to do so by some type of switch. The rotation and its intervals may be configured by software or other mechanisms to achieve the desired degree of rotation and the interval of rotation. An example illustration of a rotating device 203 is provided and discussed in greater detail below with FIG. 3A.

In an embodiment, the pressing device 201 and heat sealing device 202 are situated at stopping points of the rotating device 203. Situated on the rotating device 203 as it stops in front of the pressing device 201 and the heat sealing device 202 are sidewalls having the rings. In some cases, the sidewalls and rings are situated on the rotating device 203 over stationary fixtures 204B (for the pressing device 201) and 204C (for the heat sealing device 202). Each fixture 204B and 204C stops in front of the pressing device 201 and the heat sealing device 202. Each fixture 204A-D is designed to receive rings, sidewalls, and bottoms that are affixed to the sidewalls.

According to an embodiment, the container assembly apparatus 200 may also include a suction device 205. The suction device 205 is also situated around the rotating device 203 at a point of stoppage, such that a completed assembled container is present over fixture 204D during a stop of the rotating device 203. The suction device 205 generates suction against an outer surface of the bottom and picks the assembled container off of the fixture 204D and transports it to a conveyor or decline apparatus where the assembled container is further automatically transported to a destination or to a further transport or storage location. An example suction device 205 is provided and discussed in detail below with respect to FIG. 3E.

In an embodiment, the container assembly apparatus 200 may also include a setup station 206. The setup station 206 may include electromechanical devices to drop rings over a fixture 204A located on the rotating device 203 and to further drop or place sidewalls over the fixture 204A and on top of the plastic ring. In other cases, the setup station 206 may include a human resource that places the ring and the sidewall over the fixture 204A. The setup station 206 is the starting point for assembling a container.

In the diagram presented with FIG. 2 it should be noted that as the fixtures 204A-D rotate from point to point their designations will change. As an example, if rotating device 203 rotates one quarter turn in the FIG. 2 then 204A would now be designated 204B, 204B designated 204C, 204C designated 204D, and 204D designated 204A. Thus, the labels were presented for purposes of illustration and are not intended to limit the description and embodiments presented herein. It should also be noted that more than 4 or less than 4 fixtures 204A-204B may be used without departing from the teachings presented herein.

The components and optional components of the container assembly apparatus 200 will now be discussed in greater detail with FIGS. 3A-3E for purposes of further illustration and comprehension.

FIG. 3A is a diagram of a rotating device 203 having a plurality of fixtures 204A-204D and which is part of the container assembly apparatus 200 of the FIG. 2, according to an example embodiment.

The sample rotating device 203 includes 4 fixtures labeled 204A-1, 204B-1, 204C-1, and 204D-1. Each fixture is affixed to a platform that holds or elevates the fixtures. The platforms are labeled 204A, 204B, 204C, and 204D. The platforms are stationary and rotate as the rotator 204E moves in a circular motion. In some cases movement of the rotator 204E is counterclockwise, although it should be understood this is shown for purposes of illustration only and is not intended to limit the embodiments presented herein, since movement could be clockwise or could change depending upon instructions given to the rotating device 204E.

Each platform is connected to the rotator 204E via a connecting apparatus labeled as 204A-2, 204B-2, 204C-2, and 204D-2. Once again it is to be understood that designation of the components change as the rotator 204E makes a movement or partial rotation in a manner that was similarly described above with respect to FIG. 2.

The rotating device 203 permits fixtures to receive rings, sidewalls, and bottoms and automatically rotate from station to station in front of a setup station 206, a pressing device 201, a heating sealing device 202, and a suction device 205.

FIG. 3B is a diagram of a setup station 206 for the container assembly apparatus 200 of the FIG. 2, according to an example embodiment. The setup station 206 may be achieved via automated, manual, or a combination of automated and manual techniques.

The setup station 206 includes a platform 204A for holding the fixture 204A-1; the platform 204A connected to a rotator 204E via connecting mechanism 204A-2. During operation of the container assembly apparatus 200 and while at the setup station 206, a sidewall 210A and ring 210B are placed over the fixture 204A-1. First, the ring 210B is placed over the fixture 204A-1 and then the sidewall 210A is placed over the fixture 204A-1 and on top of the ring 210B. Once this processing occurs the rotating device 206 is enabled or configured to move the fixture 204A-1 to the pressing device 201, such that the fixture 204A-1 is now designated as fixture 204B-1.

FIG. 3C is a diagram of a pressing device 201 for the container assembly apparatus 200 of FIG. 2, according to an example embodiment. The pressing device 201 includes an overhang 201A from which a presser 201B is suspended and capable of being activated. The pressing device 201 also includes a gripping or stabilizing device 201C that includes extending arms 204D and stabilizers 201E.

During operation a fixture 204A-1 having a ring 210B and a sidewall 210A are moved about a rotating device 203 to a position directly under overhang 201A. At this point, the fixture 204A-1 receives a designation of 204B-1 and it is located on an elevated platform 204B and affixed to a rotator 204E via a connection mechanism 204B-2.

Once the fixture 204B-1 is situated in front of the pressing device 201 by being under the overhang 201A a switch is triggered which first activates the gripping device 201C. The gripping device 201C then extends its arms 204D upward so as to encircle the plastic ring 210B with the stabilizers 201E. Next, the stabilizers 201E close in around the ring 210B to brace the ring 210B.

Once the stabilizers 204E have closed in around the ring 210B, the presser 201B is activated from the overhang 201A. The presser 201B moves downward onto the top of the sidewall 210A and forces the sidewall 210A into the ring 210B which is held steady and braced by the stabilizers 201E. Once a configured amount of force is exerted the presser 201B moves upward toward the overhang 201A and away from the sidewall 210A. Next, the stabilizers 201E release outward from grip of the ring 210B and the extenders 204D compress downward. At this point a switch is activated and the rotator 204E moves the fixture 204B-1 from the pressing device 201 to a heat sealing device 202.

FIG. 3D is a diagram of a heat sealing device 202 for the container assembly apparatus 200 of FIG. 2, according to an example embodiment. After the ring 210B is pressed into the sidewall 210A at the pressing device 201 it is rotated about the rotating device 203 and is stopped and situated in front of the heat sealing device 202. This triggers or activates a switch that initiates the heat sealing device 202. Moreover, for purposes of illustration once the sidewall 210A and the affixed ring 210B are situated in front of the heat sealing device 202, the designation of the fixture is 204C-1 and it is situated over an elevated platform 204C that is connected to a rotator 204E via a connection mechanism 204C-2. Again, these designations are relative and change as the rotating device 203 rotates.

The heat sealing device 202 includes an overhead platform 202A from which a heat sealer 202B extends and is activated downward onto the bottom of the sidewall 210A and a bottom 210C, which is initially not affixed or adhered to the sidewall 210A. The sidewall 210A is situated over the fixture 204C-1 in an upside down orientation, such that the ring 210B is affixed to a top of the sidewall 210A and the bottom 210C is placed over a bottom of the sidewall 210A.

In some embodiments, another device shoots or places the bottom 210C over the bottom of the sidewall 210A and once that device retracts or after some configurable period of time, the heat sealer 202B is activated.

Once activated, the heat sealer 202B extends downward around the bottom portion of the sidewall 210A and over the bottom 210C. The heat sealer 202B then heats coatings associated with the bottom 210C and/or the inside and/or outside of the sidewall's perimeter to melt the coatings and press the bottom 210C against the inside and/or outside perimeter of the sidewall 210A. This creates a heat seal and affixes the bottom 210C to the sidewall 210A.

The heat sealer 202B may be any device designed to heat seal the bottom 210C to the sidewall 210A. Once the bottom 210C is heat sealed to the sidewall 210A, the rotating device 203 is again triggered to rotate a defined distance. In some cases, this rotation situates the container in front of a suction device 205.

FIG. 3E is a diagram of a suction device 205 for the container assembly apparatus 200 of FIG. 2, according to an example embodiment. The suction device 205 is triggered into operation when the rotating device 203 places a fixture 204D-1 in front of it; the fixture 204D-1 situated on an elevated platform 204D and connected to a rotator 204E via a connection mechanism 204D-2. Moreover, the fixture 204D-1 includes a container that is now assembled with a sidewall 210A, having a ring 210B affixed to the top of the sidewall 210A and a bottom 210C heat sealed to the bottom of the sidewall 210A. Again, the container is situated upside down on the fixture 204D-1 such that the outer surface of the bottom 210C is facing the suction device 205.

The suction device 205 includes a stationary arm 205A, suctions 205B, and a moving robotic arm 205C. The robotic arm 205C moves the suctions 205B over the container and places the suctions 205B in contact with the bottom 210C and activates suction to temporarily adhere the container to the suctions 205B. Next, the arm 205C moves the container off the fixture 204D-1 and toward a decline or conveyor 205D. The suction is then stopped from the suctions 205B and the container is released. The container then rolls down the incline or is moved to a desired destination away from the container assembly apparatus 200.

When the rotating device 203 rotates again, the fixture is empty and becomes designated 204A-1 and when it is stopped it is again situated in front of the setup station 206. The process of the container assembly apparatus 200 continues for a desired amount of time or number of assembled containers.

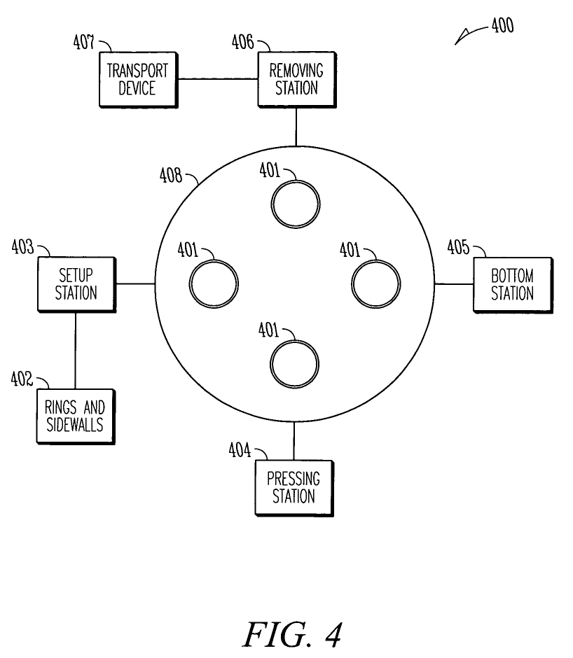

FIG. 4 is a diagram of a container assembly system 400, according to an example embodiment. The container assembly system 400 is implemented with electrical and mechanical devices for purposes of automatically assembling containers. In an embodiment, the containers are commercial frozen novelty containers having paper-based sidewalls 210A with top plastic rings 210B and with heat sealed paper-based bottoms 210C. The container assembly system 400 performs the processing of the method 100 and may include the devices of the container assembly apparatus 200 of FIGS. 2 and 3A-3E.

The container assembly system 400 includes a plurality of fixtures 401, a setup station 403, a pressing station 404, and a bottom station 405. According to some embodiments, the container assembly system 400 may also include a removing station 406, a transport device or apparatus 407, and/or a rotating device 408. Each of these will now be discussed in turn.

The fixtures 401 are stationary or are stationary on a rotating device 408. The fixtures 401 are desired to receive rings and sidewalls 402 over the outside of the fixtures 401. Each fixture 401 is situated in front of a station 403, 404, 405, and 406. In some cases, the stations 403, 404, 405, and 406 rotate about stationary fixtures 401. In other cases, as described in detail above, the fixtures 401 rotate in front of the stations 403, 404, 405, and 406.

The setup station 403 is a location where a fixture 401 receives a plastic ring and sidewall 402 for an as yet unassembled container. The setup station 403 may utilize a human resource to achieve this initial configuration about the fixture 401 or may include electromechanical devices that automatically achieve the configuration. Examples of setup stations 403 were provided above with the container assembly apparatus 200 of FIG. 2 and with FIG. 3B.

The pressing station 404 is an automated processing station that uses electromechanical devices to force the sidewall into a ring 402. Examples devices for achieving this were discussed and presented above with the container assembly apparatus 200 of FIG. 2 and with FIG. 3C.

The bottom station 405 is an automated processing station that uses electromechanical devices to place a bottom over the sidewall 202 and adhere or affix the bottom in an automated fashion to the sidewall 202. Some examples of heat sealing the bottoms were presented above with the container assembly apparatus 200 of FIG. 2 and with FIG. 3D. In fact, any electromechanical device designed to automatically affix or adhere the bottom to a sidewall 202 may be used and some embodiments do not have to include exclusively a heat sealing technique.

In an embodiment, the container assembly system 400 may also include a removing station 406. The removing station transports or removes a finished container (represented by a sidewall with an affixed ring 202 and a bottom) from the fixture 401. According to an embodiment, the removing station 406 may interface with a transport device 407 for purposes of moving the removed container away from the container assembly system 400 to a destination or further transportation location. The removing station 406 includes automated electro-mechanical devices that automatically remove finished and assembled containers from the fixtures 401. Examples of a suction device were provided above with respect to FIG. 3E. The transport device 407 may be a conveyor or a decline apparatus; examples of such a device was also presented above with respect to FIG. 3E.

According to an embodiment, the container assembly system 400 also includes a rotating device 408 that includes the fixtures 401. The rotating device is an automated electromechanical device that moves the fixtures 401 around from station to station to perform the processing associated with assembling the containers. Example rotating devices 408 were presented above with the container assembly apparatus 200 of FIG. 2 and FIG. 3A.

It is now understood how a container may be assembled in an automated fashion. The container is moved about stations that perform processing for affixing a plastic ring, sealing a bottom, and in some cases removing the assembled container.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
receiving a plastic ring over a fixture;
receiving a sidewall of a container over the fixture and on top of the plastic ring;
pressing the sidewall into the plastic ring; and
affixing a bottom to an end of the sidewall that is opposite the plastic ring.

2. The method of claim 1 further comprising, transferring the sidewall with the bottom and plastic ring to a conveyor.

3. The method of claim 1, wherein transferring further includes generating suction on a surface of the bottom in order to lift the sidewall off the fixture and transfer the sidewall to the conveyor.

4. The method of claim 1 further comprising, automatically rotating the fixture around stations to perform the method.

5. The method of claim 1, wherein pressing further includes gripping the sidewall and pressing an opposite end of the sidewall down into the plastic ring to adhere the sidewall to the plastic ring.

6. The method of claim 1, wherein affixing further includes:
sliding the bottom in between a bottom opening of the end and a heat sealing device; and
activating the heat sealing device to heat seal the bottom to the bottom opening of the sidewall.

7. The method of claim 1 further comprising, transporting the sidewall with the bottom and plastic ring by rolling the sidewall down a decline to a destination.

8. A container assembly apparatus, comprising:
a pressing device to affix a ring to a sidewall;
a heat sealing device to heat seal a bottom to the sidewall; and
a rotating device to move the sidewall from the pressing device to the heat sealing device.

9. The container assembly apparatus of claim 8 further comprising, a suction device to remove the sidewall from the rotating device and place the sidewall on a conveyor.

10. The container assembly apparatus of claim 8 further comprising, a fixture affixed to the rotating device to receive the ring, the sidewall, and the bottom.

11. The container assembly apparatus of claim 8, wherein the pressing device further includes a gripping device to hold the ring steady while the pressing device pushes the sidewall into the ring.

12. The container assembly apparatus of claim 8, wherein the heat sealing device further includes a device to place the bottom over an opposite end of the sidewall from the ring and to heat seal the bottom to a perimeter of the sidewall to enclose the opposite end.

13. The container assembly apparatus of claim 8, wherein the pressing device and the heat sealing device are located around the rotating device at predefined locations.

14. The container assembly apparatus of claim 8 further comprising, a setup station, wherein the setup station includes a fixture that receives the ring and the sidewall, and wherein the rotating device is to rotate with the ring and the sidewall covering the fixture from the setup station to a location associated with the pressing device and then to a location associated with the heat sealing device.

15. A container building system, comprising:
a plurality of fixtures, each fixture to receive a sidewall and a ring around the outside of each of the fixtures;
a setup station to initially place one of the sidewalls and one of the rings over one of the fixtures;
a pressing station to snap the sidewall into the ring; and
a bottom station to affix a bottom to each of the sidewalls.

16. The container building system of claim 15 further comprising, a removing station to remove each of the sidewalls from its respective fixture after the respective ring and bottom are affixed.

17. The container building system of claim 16 further comprising, a transport device to move each removed sidewall away from the container building system.

18. The container building system of claim 15 further comprising, a rotating device to move the fixtures from the setup station to the pressing station and from the pressing station to the bottom station.

19. The container building system of claim 18, wherein the fixtures are affixed to the rotating device, and wherein the plurality of fixtures include at least three fixtures.

20. The container building system of claim 15, wherein the pressing and bottom stations are associated with devices that automatically snap the rings into the sidewalls and affix the bottoms to the sidewalls.
